(19) United States
(12) Patent Application Publication
(10) Pub. No.: US 2013/0253947 A1
(43) Pub. Date: Sep. 26, 2013

(54) SYSTEM FOR MIGRATING PERSONAL HEALTH INFORMATION AND METHODS THEREOF

(71) Applicant: David Drabo, Mesa, AZ (US)

(72) Inventor: David Drabo, Mesa, AZ (US)

(21) Appl. No.: 13/425,010

(22) Filed: Mar. 20, 2012

(51) Int. Cl. G06Q 50/24

(52) U.S. Cl. 705/3

(57) ABSTRACT

Generally described, the present disclosure relates to medical information and more particularly, to a system for migrating personal health information and methods thereof. In an illustrative embodiment, the migration platform can include an importation and reconciliation module, migration form and exportation module. The importation module can load the migration platform with known information from a source system. In turn, the reconciliation module can determine what elements can be automatically transferred to the target system and which elements to apply migration business rules to. A migration technician can convert elements which cannot be automatically migrated. The migration form can break down and group the patient's chart into sections and elements for review by the technician. The migration form can also display the elements in an easy-to-follow format and manage pairs of information. The exportation module of the migration platform can take the completed chart, after review, and populate the target system.

### TECHNICAL FIELD

This disclosure generally relates to data, and more particularly, to transferring medical information from one system to another while enforcing business rules established by the target system.

### BACKGROUND

Government regulations, expensive hardware and software, shortage of qualified employees, increasing competition and wages all compel medical practices to reduce costs while maintaining the highest level of quality care to their patients. To alleviate these pressures, Electronic Medical Records (EMRs) require less processing time when compared with paper medical records. EMRs tend to be a part of a local stand-alone Health Information System (HIS) that allows storage, retrieval and modification of records. Using a workstation, these EMRs are gathered from the HIS and analyzed for relevant information. Using an EMR to read and write a patient's record is not only possible through a workstation but depending on the type of system and health care settings can also be possible through mobile devices that are handwriting capable.

The development of standards for EMR interoperability is at the forefront of the national health care agenda proposed by President Barrack Obama. EMRs, while an important factor in interoperability, are not a critical first step to sharing data between practicing physicians, pharmacies and hospitals. Many physicians currently have computerized practice management systems that can be used in conjunction with a Health Information Exchange (HIE), allowing for first steps in sharing patient information (lab results, public health reporting) which are necessary for timely, patient-centered and portable care.

The future vision of many connected health systems is the ability to exchange EMRs between various workstations including tablets and smartphones. Nevertheless, many modern systems have standards specific to the EMRs which they maintain and can use. A mixture of these standards generally tend to be incompatible with one another leaving the EMR systems unusable. Current methods rely on an individual to copy, paste and fill in data between multiple forms and apply “known” business rules manually when transferring data between systems. A need therefore exists for a system for migrating personal health information and methods thereof that overcome those issues described above. These, as well as other related advantages, will be described in the present disclosure.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a computer-implemented method for transferring medical information to a target is provided. The method can include importing an electronic medical record from a source and extracting a plurality of entries from the electronic medical record from the source. In addition, the method can include reconciling each entry individually from the plurality of entries to a standard compatible with the target and generating a form from the plurality of entries for review. The method can also include generating an electronic medical record for the target through the plurality of entries and transmitting the electronic medical record for the target.

In accordance with another aspect of the present disclosure, a system is provided. The system can include a server for receiving patient information from a source, extracting at least one element from the patient information, reconciling the at least one element to standards compatible with a target and transmitting the at least one element to the target.

In accordance with yet another aspect of the present disclosure, an electronic medical record migration system is provided. The system can include at least one processor and a memory operatively coupled to the processor, the memory storing program instructions that when executed by the processor, causes the processor to perform processes. The processes can include importing a source electronic medical record, parsing the source electronic medical record into at least one source entry, converting the at least one source entry to at least one target entry through codified system standards of a target, generating generate a target electronic medical record through the at least one target entry and transmitting the target electronic medical record.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram showing migration of personal health information from at least one source to a target in accordance with one or more aspects of the present disclosure;

FIG. 2 is a block diagram illustrating elements in accordance with one or more aspects of the present disclosure;

FIG. 3 is a block diagram that shows an illustrative architecture used for operating the exemplary migrator platform in accordance with one or more aspects of the present disclosure;

FIG. 4 is a flow chart that shows illustrative processes for converting a medical records from at least one source to a target in accordance with one or more aspects of the present disclosure;

FIG. 5 is a flow chart that shows illustrative processes for the importation module in accordance with one or more aspects of the present disclosure;

FIG. 6 is a flow chart that shows illustrative processes for the reconciliation module in accordance with one or more aspects of the present disclosure;

FIG. 7 is a flow chart that shows illustrative processes for the migration data form in accordance with one or more aspects of the present disclosure;

FIG. 8 is a screen shot that shows exemplary elements migrated from at least one source in accordance with one or more aspects of the present disclosure;

FIG. 9 is another screen shot that shows exemplary elements migrated from at least one source in accordance with one or more aspects of the present disclosure; and

FIG. 10 is yet another screen shot that shows exemplary elements migrated from at least one source in accordance with one or more aspects of the present disclosure.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the present disclosure relates to medical information and more particularly, to a system for migrating personal health information and methods thereof. In an illustrative embodiment, the migration platform can include an importation and reconciliation module, migration form and exportation module. The importation module can load the migration platform with known information from a source system. In turn, the reconciliation module can determine what elements can be automatically transferred to the target system and which elements to apply migration business rules to. A migration technician can convert elements which cannot be automatically migrated. The migration form can break down and group the patient's chart into sections and elements for review by the technician. The migration form can also display the elements in an easy-to-follow format and manage pairs of information. The exportation module of the migration platform can take the completed chart, after review, and populate the target system.

A number of advantages can be provided through the migration platform described above. The migration platform can transfer patient information from one system to another applying business rules or codified system standards of a target. Data validation, enforcement of rules for target selections, enforcement of rules for quality control review and calculation for a technician's payroll can be verified through the migration form. Furthermore, granular control can be provided through individually parsed elements from the patient information. The parsed elements can provide an easy-to-use system and lead to a more efficient productivity. Other advantages will become apparent from the discussion provided below.

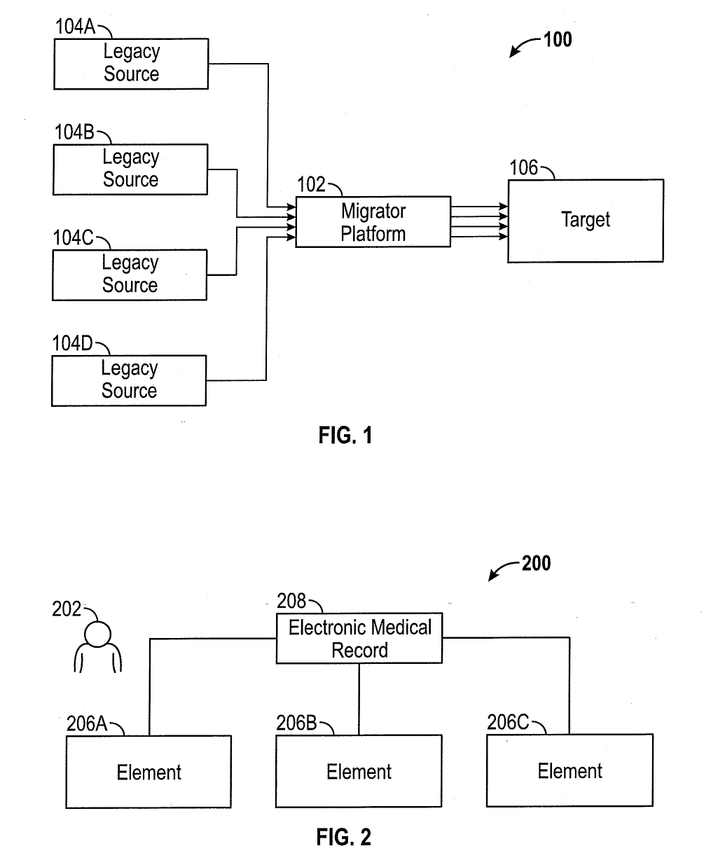

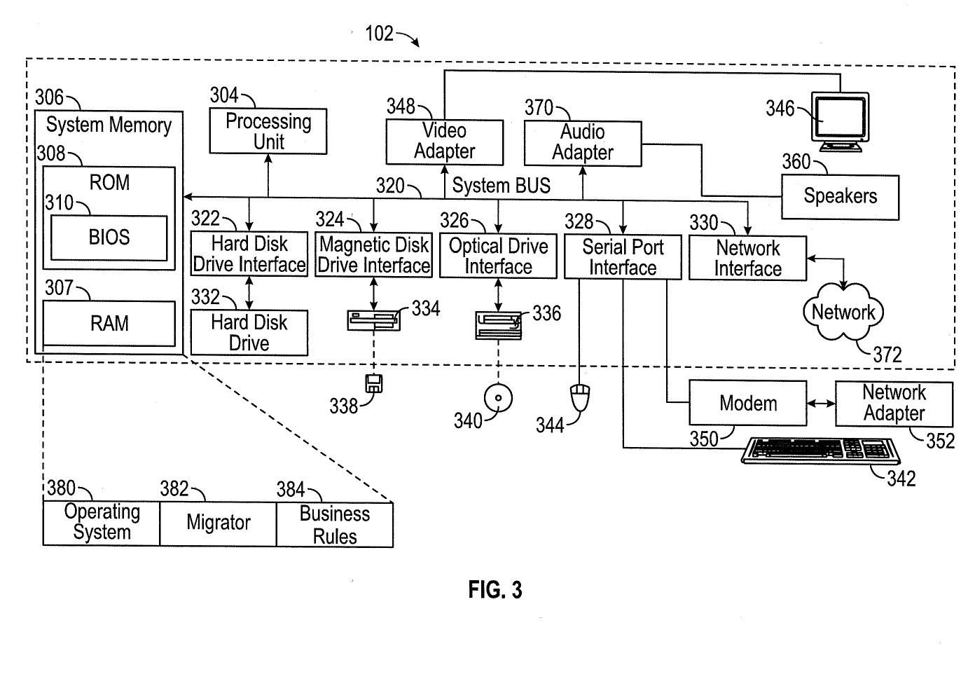

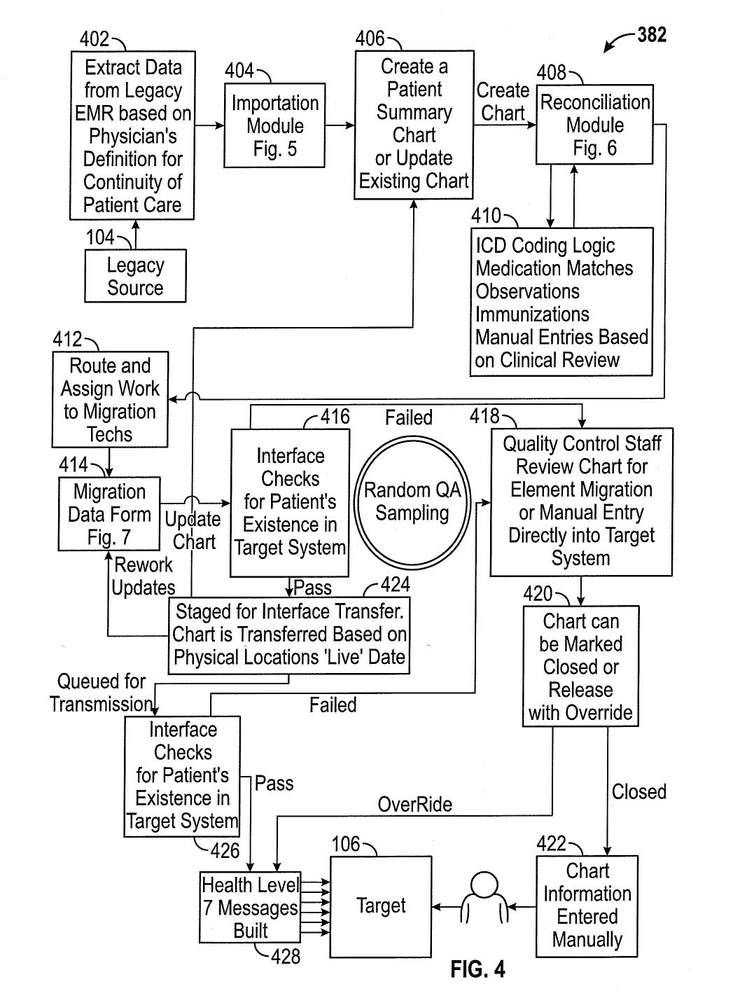

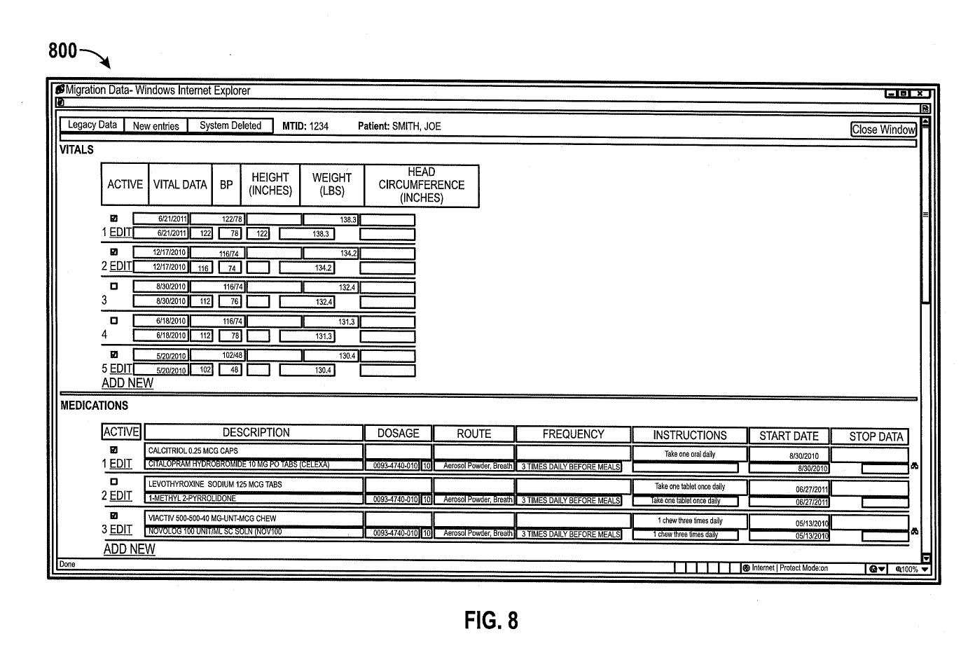

A typical environment for a migration platform will be described in FIG. 1. FIG. 2 shows breakdown of elements, or entries, from an Electronic Medical Record (EMR), while FIG. 3 depicts exemplary hardware and software for the migration platform. FIGS. 4 through 7 will provide exemplary flow charts for the migration platform and FIGS. 8 through 10 show migration data forms. The FIGURES are representative embodiments of the present disclosure, but are not intended to limit the scope of the migration platform.

Turning now to FIG. 1, a block diagram showing migration of personal health information from at least one source 104A, 104B, 104C and 104D (collectively sources 104) to a target 106 in accordance with one or more aspects of the present disclosure is shown. The migrator platform 102, provided within the environment 100, can transfer medical patient information from one source 104 to a target 106 with the ability to apply and enforce business rules of the target 106, or other medium for an EMR.

The migrator platform 102 can communicate with a number of sources 104. The sources 104 can each provide an EMR, or multiple EMRs, for a specific patient. A single source 104, individually, can also provide an EMR. The sources 104 can each have their own format, which can be different from the standard used by the target 106, or even other sources 104. The sources 104 can be referred to as legacy sources as they maintain the EMR that is intended to be migrated over the migrator platform 102 to the target 106.

EMRs, known to those skilled in the relevant art, can be computerized medical records created by the source 104. The source 104 can be an organization that delivers care, such as a hospital or physician's office. EMRs tend to be a part of a local stand-alone health information system that allows storage, retrieval and modification of records within the source 104. The EMRs can be loaded into a repository and be accessible through a number of workstations. Each of the workstations typically use the same standard format for an EMR. The workstations operating within the legacy sources 104 typically communicate with one another through a local area network (LAN) or wireless area network (WAN) as most EMRs are portable and can be transferred from one workstation to another without restriction in the organization. Other networks can include a personal area network (PAN), campus area network (CAN), metropolitan area network (MAN), global area network (GAN) or combination thereof. Such networking environments are commonplace in office networks, enterprise-wide computer networks, intranets and the Internet, which are all types of networks. Security features can be provided that can be implemented from one workstation to another that can protect the EMRs. Workstations, for purposes of the present disclosure, can refer to any type of device that can receive and provide EMRs. A workstation can include, but is not limited to, a computer, tablet, smartphone, dedicated or non-dedicated device or any other type of electronic device that can be used for EMRs.

Traditionally, paper-based medical records were used by the legacy sources 104. Electronic records helped with the standardization of forms, terminology and abbreviations, and data input. A number of companies have come out with the digitization of forms facilitating the collection of data for epidemiology and clinical studies. When the forms were submitted at a legacy source 104, they were scanned in and electronically converted to readable text or other format that would help the facilitation of medical records. As will be disclosed in the present disclosure, the ability to exchange records between different EMR systems (“interoperability”) having different standards can facilitate the coordination of healthcare delivery in non-affiliated healthcare facilities.

Because of the challenges posed by different workstations within the legacy sources 104, and the conversion of the standards among them, the migrator platform 102 can be used to apply codified system standards of a target 106 to facilitate use of the EMRs. The migrator platform 102, as will be shown in the following FIGURES, can be used to convert the EMRs for use by a target 106. In one embodiment, the legacy sources 104 can be connected to the migrator platform 102 through a network, not shown. Many types of networks can be integrated into the environment 100, which were described above.

While a number of embodiments were shown for the environment 100 described above, the migrator platform 102 can also be placed in other systems. By way of non-limiting examples, the migrator platform 102 can communicate with a single source 104. Furthermore, the source 104, migrator platform 102 and target 106 can each be within the same organization where workstations are incompatible with one another. A single LAN can be used for the communications. The environment 100 can also be used to disperse reconciled EMRs to multiple targets, not shown. A number of configurations, known to those skilled in the relevant art can be implemented and are not limited to those shown in FIG. 1.

Previously, EMRs were transported as a whole document. In the present disclosure, the EMR from the sources 104 can be broken into at least one element, the term being interchangeable with entry. FIG. 2 is a block diagram illustrating elements 206A, 206B and 206C (collectively elements 206) in accordance with one or more aspects of the present disclosure. As shown within the environment 200, a patient 202 can have an EMR 208 tied to a number of elements 206. For the present disclosure, an element 206 can be an individual entry in a chart. Non-limiting examples of this would be a single medication or a single immunization. Charts can contain numerous entries. The migrator platform 102 can treat each individual element 206 as a unique “document” with creation, update, status and business rules that can be manipulated per scope.

Each element 206 can be treated as a unique object with independent attributes allowing for a unique state. The method of breaking a patient's chart into individual elements 206 and presenting them to a migration user in element pairs on a single form allows for granular control, ease of use and far superior productivity. A separate document can be setup for each element 206. By way of a non-limiting example, the single medication described before can be established within a document and the single immunization can be provided within its own individual document.

Attributes, changes, states and history of the element 206 can be kept. Attributes for the element 206 can include source information, doctor/nurse/administrator who took the information in, patient identification, etc. Changes can also be kept tracked of. For example, the doctor or nurse who made a change to the entry 206 can be kept track of. In one embodiment, the state of an entry 206 can be maintained. For example, if the entry 206 is a prescription and the prescription is no longer valid, then it can indicate an invalid state. The history of each entry 206 can be maintained. By creating such a document for each entry 206, the migrator platform 102 can handle the information piece-meal instead of a whole.

Furthermore, by breaking out the EMR 208 into elements 206, the migrator platform 102 can be used to pick and choose the type of data that is incoming. For example, some data may not be related to a course of treatment, for example, whether or not a dentist pulled out a patient's molar should not affect what type of glasses an optometrist should prescribe. Through the migrator platform 102, entries 206 within scope can be picked and chosen instead of taking the entire EMR 208.

As will be shown, the migrator platform 102 can be used to reconcile entries 206 from the source 104 to the target 106. When converted an element pair can be created. An element pair is a unique way that the migrator platform 102 presents the information to the end user with the legacy source 104 and EMR target information. This pairing can allow for the transformation of the element 206 from the legacy systems standards to the target systems standards while maintaining the required business rules and/or codified system standards. Furthermore, this provides ease of use by a migration technician.

In one embodiment, the migrator platform 102 can be maintained on a traditional computing system. FIG. 3 is a block diagram that shows an illustrative architecture used for operating the exemplary migrator platform 102 in accordance with one or more aspects of the present disclosure. The hardware can include a processing unit 304, a system memory 306, and a system bus 320 that operatively couples various system components, including the system memory 306 to the processing unit 304. There can be only one or there can be more than one processing unit 304, such that the processor of computer can include a single central processing unit (CPU), or a plurality of processing units, commonly referred to as a parallel processing environment. The platform 102 can be a conventional computer, a distributed computer, a web server, a file server, a self-contained unit and any other type of computer. Furthermore, those skilled in the relevant art will appreciate that the components provided within the platform 102 can be distributed over many computer-like systems.

The system bus 320 can be any of several types of bus structures including a memory bus or memory controller, a peripheral bus, a switched fabric, point-to-point connections, and a local bus using any of a variety of bus architectures. The system memory 306 can also be referred to as simply the memory, and includes read only memory (ROM) 308 and random access memory (RAM) 307. A basic input/output system (BOIS) 310, containing the basic routines that help to transfer information between elements 206 within the migrator platform 102, such as during start-up, is stored in ROM 308. The migrator platform 102 further includes a hard disk drive 332 for reading from and writing to a hard disk, not shown, a magnetic disk drive 334 for reading from or writing to a removable magnetic disk 338, and an optical disk drive 336 for reading from or writing to a removable optical disk 340 such as a CD ROM or other optical media.

The hard disk drive 332, magnetic disk drive 334, and optical disk drive 336 can be connected to the system bus 320 by a hard disk drive interface 322, a magnetic disk drive interface 324, and an optical disk drive interface 326, respectively. The drives and their associated computer-readable medium provide nonvolatile storage of computer-readable instructions; data structures, e.g., a catalog and a contextual-based index; program modules, e.g., a web service and an indexing robot; and other data for the migrator platform 102. It should be appreciated by those skilled in the relevant art that any type of computer-readable medium that can store data that is accessible by a computer, for example, magnetic cassettes, flash memory cards, digital video disks, RAM, and ROM, may be used in the exemplary operating environment.

A number of program modules can be stored on the hard disk 332, magnetic disk, optical disk 336, ROM 308, or RAM 307, including an operating system 380, migrator 382 and business rules 384. The migrator 382, as will be shown in the following FIGURES, can be used to transfer medical patient information from one source 104 to a target 106 with the ability to apply and enforce business rules 384 of the target 106.

Continuing with FIG. 3, a user can enter commands and information into the migrator platform 102 through input devices such as a keyboard 342 and pointing device 344, for example, a mouse. This information can be used in conjunction with the migration form, which will be described below. Other input devices (not shown) can include, for example, a microphone, a joystick, a game pad, a tablet, a touch screen device, a satellite dish, a scanner, a facsimile machine, and a video camera. These and other input devices are often connected to the processing unit 304 through a serial port interface 328 that is coupled to the system bus 320, but can be connected by other interfaces, such as a parallel port, game port or a universal serial bus (USB).

A monitor 346 or other type of display device can also be connected to the system bus 320 via an interface, such as a video adapter 348. The monitor 346 can be in the form of a touch screen device removing the need for any input devices. In addition to the monitor 346, computers typically include other peripheral output devices, such as a printer and speakers 360, which can be connected via the audio adapter 370. These and other output devices are often connected to the processing unit 304 through the serial port interface 328 that is coupled to the system bus 320, but can be connected by other interfaces, such as a parallel port, game port, or a universal serial bus (USB).

The migrator platform 102 can operate in a networked environment using logical connections to one or more remote computers. These logical connections can be achieved by a communication device coupled to or integral with the platform 102. The platform 102 can be logically connected to the network 372, as described above. When used in a LAN environment, the platform 102 can be connected to the local network through a network interface or adapter 330, which is one type of communication device. When used in a WAN environment, the platform 102 typically includes a modem 350, a network adapter 352, or any other type of communications device for establishing communications over the WAN. The modem 350, which can be internal or external, is connected to the system bus 320 via the serial port interface 328. In a networked environment, program modules depicted relative to the platform 102, or portions thereof, can be stored in a remote memory storage device. It is appreciated that the network connections shown are exemplary and other methods of and communications devices for establishing a communications link between the computers can be used.

While hardware and software components for the migrator platform 102 have been described, similar components can be provided within the legacy sources 104 and the target 106. By ways of non-limiting examples, both the legacy sources 104 and the target 106 can operate on a computing system, server or the like. Furthermore, the resources presented above can be distributed over a cloud known to those skilled in the relevant art. To access information from the cloud, the migrator platform 104 can retrieve the information from the cloud and place it back into the cloud when done reconciling the elements 206. In one embodiment, the migrator platform 104 can be part of the cloud itself.

Referring to FIG. 4, a flow chart that shows illustrative processes for converting personal health information from at least one source 104 to the target 106 in accordance with one or more aspects of the present disclosure is shown. While a number of modules are shown within the flow chart, those skilled in the relevant art will appreciate that fewer or more processes can be used to reconcile legacy EMRs to a target EMR. Furthermore, the processes do not necessarily have to occur in the order disclosed. The migrator 382 can operate on top of the RAM 307 within the system memory 306 of the migrator platform 102. The migrator 382, while shown as being implemented in software, can also be implemented in hardware or a combination of both.

Initially, at module 402, the migrator 382 can extract EMRs 208 from a legacy EMR source 104. The EMRs 208 can be pulled from one legacy source 104 or many legacy sources 104. The migrator 382 can retrieve information that is relevant to the particular target 106. This can be based on the physician's definition for continuity of a patient's care. The information pulled from the legacy source 104 can be based on a specific treatment that a target 106 requires. By way of a non-limiting example, if at the target 106 a surgery is to be performed on a patient's stomach, information relating to any source EMR 208 can be pulled by the migrator 382 or physician at module 402 related to the operation. Alternatively, all information can be pulled related to the patient.

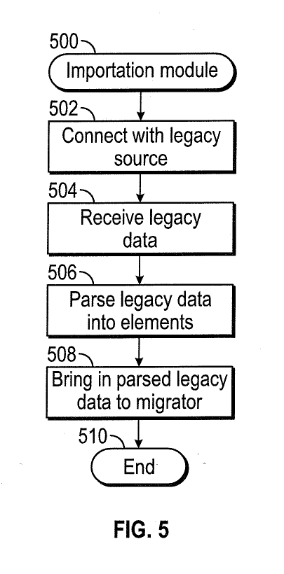

At module 404, the legacy EMRs 208 from the sources 104 can be parsed and imported to the migration platform 102 through the migrator 382. FIG. 5 is a flow chart that shows illustrative processes for the importation module 404 in accordance with one or more aspects of the present disclosure. This process can load the migration platform 102 with known information from the source 104, which can be relevant to the target 106. In one embodiment, all information can be pulled, relevant or not. The processes can begin at block 500.

At block 502, the migrator 382 can connect with the legacy source 104. This connection can be established through a dedicated or newly established port with the legacy source 104. A number of different protocols can be used to interact with the legacy source 104 to retrieve the EMRs 208. At block 504, the legacy data can be received from the source 104. This can occur through one of the ports opened for the source 104. An individual port can be opened to a workstation within the source 104.

At block 506, the incoming EMR 208 can be parsed into elements 206, or entries. One or many elements 206 can be parsed from the EMR 208. The number of elements 206 that are parsed can be dependent on the needs of the target 106. By way of a non-limiting example, the migrator 382 can parse out any allergy entries 206 from the source EMRs 208 when a new shot is about to administered at the target 106. The parsed entries 206 can then be brought into the migrator platform 102 through the migrator 382 at block 508. The processes can end at block 510.

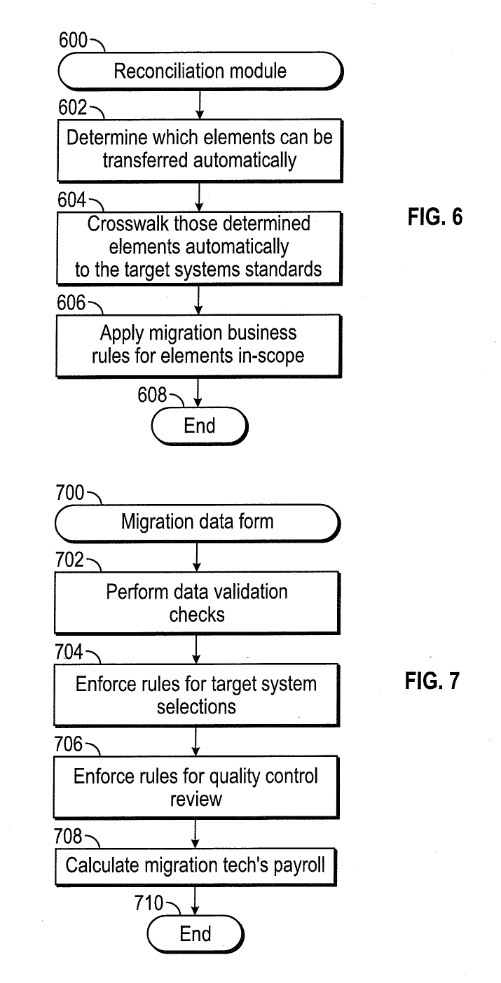

Continuing with module 406 in FIG. 4, and when the importation module 404 has successfully captured incoming entries 206 from at least one EMR 208, a patient summary chart can be updated or created depending on whether the patient is within the migrator platform 102 already. At module 408, the elements 206 can be reconciled to the business rules 384 established by the target 106. FIG. 6 is a flow chart that shows illustrative processes for the reconciliation module 408 in accordance with one or more aspects of the present disclosure. The reconciliation module 408 can apply migration business rules 384 for elements in-scope. The process for reconciling the elements 206 within the source 104 using the rules 384 established by the target 106 can begin at block 600.

At block 602, the migrator 382 can determine which elements 206 can be transferred through automatically when the same standard is used between the source 104 and the target 106. At block 604, those elements 206 that use the same standard can be crosswalked to the target 106 as there will be nothing to do with these elements 206. The migrator 382 can then apply the migration business rules 384 for elements in-scope at block 606 that do not have the same standard. The processes can end at block 608.

Returning to FIG. 4, at reconciliation module 408, the entries 206 can be converted from one form to another depending on those rules established by the target 106. The reconciliation module 408 can interact with module 410 wherein the business rules 384 have been established. Within module 410, International Classification of Diseases (ICD) coding logic can be implemented to reconcile entries 206 from the legacy source 104 to the target 106. ICD represents a medical classification system that provides codes to classify diseases and a wide variety of signs, symptoms, abnormal findings, complaints, social circumstances, and external causes of injury or disease. Under this system, health conditions can be assigned to a unique category and given a code, up to six characters long. Such categories can include a set of similar diseases. For purposes of illustration, a legacy source 104, for an element 206, can be classified under one set of diseases under ICD which can be different from another set of diseases established by the target 106. Under the reconciliation module 408, these classifications, between the source 104 and the target 106, can be rectified.

Medication matches can also be implemented within the module 410. As provided earlier, the elements 206 can be associated with a number of categories including medications. Medications can be converted through the reconciliation module 408 to those used by the target 106. Observations, immunizations and manual entries based on clinical review can also be used by the reconciliation module 410. Typically, these transformations can occur automatically through the migrator 382 using those business rules 384 established by the target 106. Rules 384 can be looked up in a database associated with the migrator platform 102 for the specific target 106 and then applied accordingly.

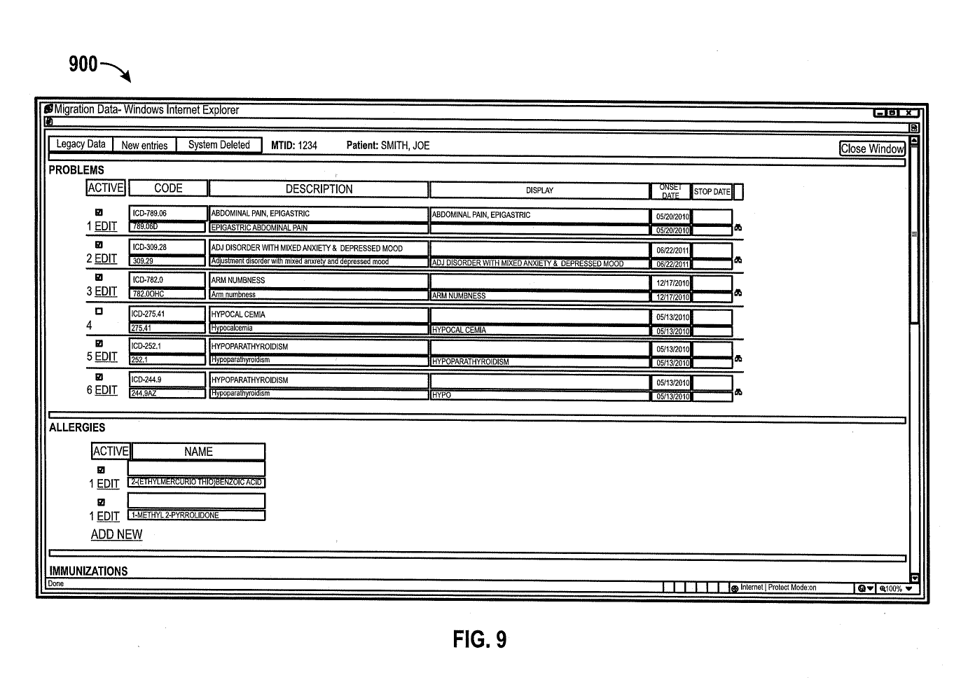

At module 412, the elements 206 can be routed and assigned to a migration technician through automated methods from the migrator 382. The entries 206 can be presented to a technician for verification. Further yet, the technician can also reconcile entries 206 that cannot be automatically converted by the reconciliation module 408. By way of a non-limiting example, FIG. 9 provides a screen shot 900 that shows one embodiment of a migration data form. While it is intended that the reconciliation occur on module 408 as much as possible, there may be some elements 206 that cannot be properly converted and require the attention of a technician. In the migration data form shown, the technician can be pointed to a set of icons (in this case binoculars) indicating that the technician should look at the elements 206. The screen shot 900 shows, through the binoculars, that the technician should reconcile the entries 206 for the ABDOMINAL PAIN, EPIGASTIC, ADJ DISORDER WITH MIXED ANXIETY & DEPRESSED MOOD, ARM NUMBNESS and HYPOPARATHYROIDISM. If a pure automated rule cannot be applied, the technician can find the most appropriate match. This can also be used as a verification step by the technician. At module 414, a migration data form can be shown to the technician. Graphical User Interfaces (GUIs) can be provided to the technician for ease of verification.

FIG. 7 is a flow chart that shows illustrative processes for the migration data form in accordance with one or more aspects of the present disclosure. The migration data form can break down and group a patient's chart into sections and elements 206. The form can display the elements 206 in an easy-to-follow method and manage pairs of information. The processes are for the technician as well as an automated process that can begin at block 700.

At block 702, the technician can perform data validation checks on the data of the migration data form. This can be used to make sure that the data has been entered correctly, for example, a patient's name. At block 704, the technician, or through an automated method, rules can be enforced for the target system selections through the migration data form, which can include verifying whether business rules 384 have been properly processed with the entries 206. At block 706, the user can enforce rules for quality control review. By way of a non-limiting example, a medication, such as Tylenol®, can have been improperly transferred by the reconciliation module 408 when it should have been Advil®. For their services, the migrator 382 can calculate the migration time it takes for billing purposes at block 708. The processes can end at block 710.

After the migration data form is certified at module 414, the migrator interface can check for the patient's existence in the target 106 at module 416. Random question and answering (QA) samplings can be performed to determine whether the reconciled entries 206 have been translated correctly. The QA samplings can be used to determine if the information extracted from the sources 104 is in proper form. Holes in the chart can appear due to inconsistencies in the reconciliation process including those translations that were done automatically and through the technician. Corruption of data can occur through the chain of custody. While QA samplings can be taken at this juncture, it can also be used in other areas of the flow chart of FIG. 4. The QA samplings can be processed by the technician, through an automated method or a combination of both. This quality control portion through the QA samplings of the chart can make sure that the whole chart is holding up to standards established by the migrator 382, both automatically and manually.

If the patient's information is not within the target 106, at module 418, element migration can be performed by a quality control staff review chart or through manual entry directly into the target 106. The quality control staff can be authorized to directly allow entrance of the elements 206 to the target 106. Typically, the staff is a person who is authorized to use the migrator platform 102 and the migrator 382. The entries 206 can also be manually entered in.

At module 420, the chart can be marked closed or released with an override. When closed, the chart information can be entered manually at module 422. If an override occurs, the migrator 382 can be used to generate messages that can be transformed into an EMR 208 at the target 106 through the split entries 206 at module 428. Manual overrides can occur as a result of the automated interface's inability to reconcile entries 206. By way of a non-limiting example, suppose that a user is adding in a medication dosage. The medication entry 206 is unknown and as such, the automated feed into the chart cannot be made. This can prompt the user to override and manually override the entry 206. Generally, this occurs when there is not enough of a two way communication and to avoid data corruption, the technician has to place the entry 206 automatically through the override.

Returning to module 416 of FIG. 4, and when the patient can be found within the target 106, the elements 206 that have been reconciled can be staged for interface transfer at module 424. QA samplings can be taken to protect the integrity of the chart. The chart can be transferred based on a physical locations ‘live’ date meaning that a determination can be made on when the target 106 was last operating and based on that determination, the migrator 382 can provide the chart. By way of a non-limiting example, if the target 106 has not been operating within the last six months, it may represent the possibility that the target 106 is no longer active and that the chart should not be sent over.

Before the chart is queued for transmission, the chart can be updated at module 406. If necessary, updates can be reworked at module 414. When the chart is ready, it can be queued for transmission. At module 426, an interface can be used to check the patient's existence in the target system 106. This can be a final stage where the technician or other authority can use to make sure that the patient is within the target 106. If it fails, at module 418, the element 206 migration can be performed by a quality control staff review chart of through manual entry directly into the target 106. When, however, the migrator 382 verifies that the patient is within the target 106, Health Level 7 (HL7) messages can be built at module 428. Other frameworks, and related standards, for the exchange, integration, sharing, and retrieval of electronic health information can be used. The messages can then be provided to the target 106. In one embodiment, this can be performed through multiple interfaces to feed discreet elements 206 in the chart to the target 106. An exportation module can be used that takes the completed chart and populates the target 106.

Turning now to FIG. 8, a screen shot 800 that shows exemplary elements 206 migrated from at least one source 104 in accordance with one or more aspects of the present disclosure is shown. The migration data form can show vitals and medications. Each of these elements 206 could have been split before from the source EMR 208, reconciled and then provided to the target 106. The migration data form can be used to edit and provide other relevant information that may not have been fully extracted from the source 104. The migration data forms can be saved or in the alternative, deleted after each migration.

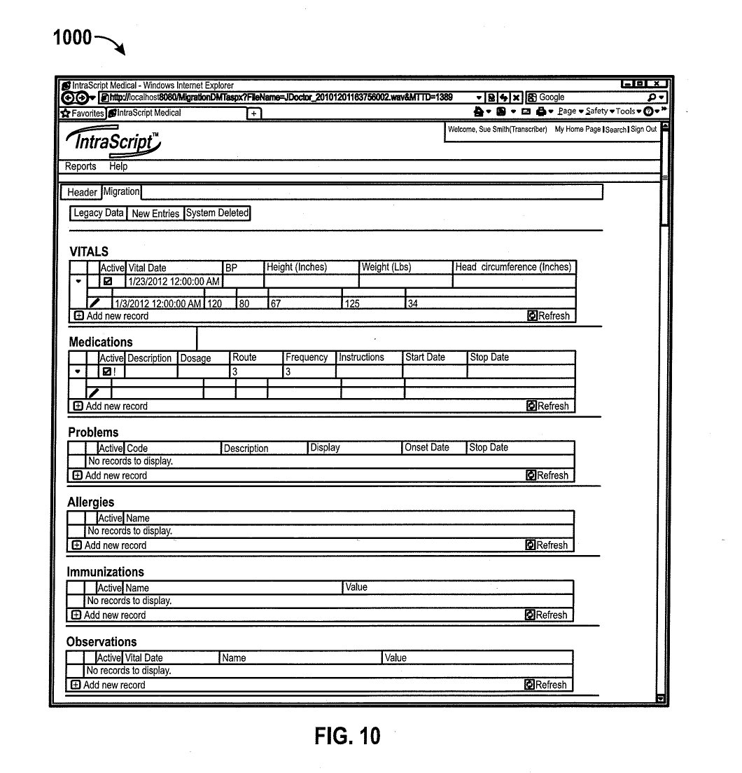

FIG. 9 is another screen shot 900 that shows exemplary elements 206 migrated from at least one source 104 in accordance with one or more aspects of the present disclosure. Problems, allergies and immunizations are other entries 206 that can be kept tracked of and reconciled within the migration data form. FIG. 10 is yet another screen shot 1000 that shows exemplary elements 206 migrated from at least one source 104 in accordance with one or more aspects of the present disclosure. The migration data form can be reviewed and edited over a typically web browser where entries 206 can be managed and reconciled. Those skilled in the relevant art will appreciate that other types of forms can be used and are not limited to those presented within FIGS. 8 through 10.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method for transferring medical information to a target comprising:
importing an electronic medical record from a source;
extracting a plurality of entries from the electronic medical record from the source;
reconciling each entry individually from the plurality of entries to a standard compatible with the target;
generating a faun from the plurality of entries for review;
generating an electronic medical record for the target through the plurality of entries; and
transmitting the electronic medical record for the target.

2. The computer-implemented method of claim 1, wherein importing the electronic medical record from the source comprises extracting the electronic medical record from a legacy source.

3. The computer-implemented method of claim 1, wherein extracting the plurality of entries from the electronic medical record from the source comprises creating a unique document for each entry.

4. The computer-implemented method of claim 1, comprising tracking creation, update, status and business rules for each entry through the form.

5. The computer-implemented method of claim 1, wherein reconciling each entry to the standard compatible with the target comprises automatically accepting each entry when each entry complies with the standard otherwise applying at least one migration business rule of the target to each entry.

6. The computer-implemented method of claim 1, wherein generating the form from the plurality of entries comprises creating the form from the plurality of entries extracted from the electronic medical record from the source and each entry reconciled to the standard compatible with the target.

7. The computer-implemented method of claim 1, comprising receiving at least one of a validation check, enforcement of rules for target selections, enforcement of rules for quality control review and calculation for payroll after generating the form for review.

8. The computer-implemented method of claim 1, wherein transmitting the electronic medical record for the target comprises automatically transmitting the electronic medical record for the target when a patient associated with the electronic medical record from the source is within the target otherwise providing an override option to transmit the electronic medical record for the target.

9. The computer-implemented method of claim 1, wherein transmitting the electronic medical record for the target comprises building at least one message for transport to the target.

10. A system comprising:
a server for receiving patient information from a source, extracting at least one element from the patient information, reconciling the at least one element to standards compatible with a target and transmitting the at least one element to the target.

11. The system of claim 10, wherein the standards comprise at least one of International Classification of Diseases (ICD) coding logic, medication matches, observations, immunizations and manual entries based on clinical review or selection.

12. The system of claim 10, wherein the server generates a migration data form for inspection, the migration data form comprising the at least one element extracted from the patient information and the at least one element reconciled to the standards compatible with the target.

13. The system of claim 12, wherein the migration data form is presented to a technician for at least one of a validation check, enforcement of a target selection, enforcement of a rule for quality control review and calculation of a payroll of the technician.

14. The system of claim 10, wherein at least two sources provide patient information.

15. An electronic medical record migration system comprising:
at least one processor; and
a memory operatively coupled to the processor, the memory storing program instructions that when executed by the processor, causes the processor to:
import a source electronic medical record;
parse the source electronic medical record into at least one source entry;
convert the at least one source entry to at least one target entry through codified system standards of a target;
generate a target electronic medical record through the at least one target entry;
transmit the target electronic medical record.

16. The electronic medical record migration system of claim 15, wherein the source electronic medical record comes from a legacy system.

17. The electronic medical record migration system of claim 15, wherein the at least one source entry comprises a single instance of at least one of a medication, vital, problem, allergy, immunization and observation.

18. The electronic medical record migration system of claim 15, wherein the memory storing program instructions, when executed, causes the processor to check for an existence of a patient associated with the source electronic medical record and transmit the target electronic medical record when the patient exists at a target otherwise request for an override to transmit the target electronic medical record.

19. The electronic medical record migration system of claim 15, wherein generating the target electronic medical record through the at least one target entry comprises building messages through HL7 and directly feeding the messages into the target electronic medical record.

20. The electronic medical record migration system of claim 15, wherein the memory storing program instructions, when executed, causes the processor to group the at least one source entry with the at least one target entry to form an element pair for processing.
